(19) United States
(12) Patent Application Publication
(10) Pub. No.: US 2016/0138419 A1
(43) Pub. Date: May 19, 2016

(54) COMPOSITE PIEZOELECTRIC APPLICATION FOR ICE SHEDDING

(71) Applicant: GENERAL ELECTRIC COMPANY, Schenectady, NY (US)

(72) Inventors: Nicholas Joseph KRAY, Mason, OH (US); David L. BEDEL, Oldenburg, IN (US); Ian Francis PRENTICS, Cincinnati, OH (US)

(21) Appl. No.: 14/901,094

(22) PCT Filed: Jun. 17, 2014
(86) PCT No.: PCT/US2014/042624

§ 371 Date: Dec. 28, 2015

Related U.S. Application Data
(60) Provisional application No. 61/840,838, filed on Jun. 28, 2013.

(51) Int. Cl. F01D 21/10; F01D 9/02

(52) U.S. Cl. CPC F01D 21/10; F01D 9/02; F05D 2260/407

(57) ABSTRACT

A flow surface comprises a composite material formed of a plurality of layers of the composite, and a piezoelectric actuator located within the layers or on an outer surface of the composite material. The piezoelectric actuator is actuatable to vibrate the composite material and one of inhibit ice build-up or shed ice which has formed.

### BACKGROUND

Present embodiments relate generally to gas turbine engines. More particularly, but not by way of limitation, present embodiments relate to apparatuses and methods for shedding ice from an airfoil or flowpath structure utilizing an embedded piezoelectric actuator.

In turbine engines, air is pressurized in a compressor and mixed with fuel in a combustor for generating hot combustion gases which flow downstream through turbine stages. These turbine stages extract energy from the combustion gases. A high pressure turbine includes a first stage nozzle and a rotor assembly including a disk and a plurality of turbine blades. The high pressure turbine first receives the hot combustion gases from the combustor and includes a first stage stator nozzle that directs the combustion gases downstream through a row of high pressure turbine rotor blades extending radially outwardly from a first rotor disk. In a two stage turbine, a second stage stator nozzle is positioned downstream of the first stage blades followed in turn by a row of second stage turbine blades extending radially outwardly from a second rotor disk. The stator nozzles direct the hot combustion gas in a manner to maximize extraction at the adjacent downstream turbine blades.

The first and second rotor disks are joined to the compressor by a corresponding rotor shaft for powering the compressor during operation. These are typically referred to as the high pressure turbine. The turbine engine may include a number of stages of static airfoils, commonly referred to as vanes, interspaced in the engine axial direction between rotating airfoils commonly referred to as blades. A multi-stage low pressure turbine follows the two stage high pressure turbine and is typically joined by a second shaft to a fan disposed upstream from the compressor in a typical turbo fan aircraft engine configuration for powering an aircraft in flight.

As the combustion gases flow downstream through the turbine stages, energy is extracted therefrom and the pressure of the combustion gas is reduced. The combustion gas is used to power the compressor as well as a turbine output shaft for power and marine use or provide thrust in aviation usage. In this manner, fuel energy is converted to mechanical energy of the rotating shaft to power the compressor and supply compressed air needed to continue the process.

One problem with static airfoils and flowpath structures is that the during flight operations, ice tends to forms on the static parts. This increases weight of the part, the engine as a whole and decreases engine efficiency. Such ice formation also affects the airflow moving over the static part, which also reduces efficiency. Ice may also form on dynamic parts as well.

Current methods of shedding ice include ducting of heat to these parts to reduce or eliminate ice formation. Since many known airfoils are formed of materials which are rigid, methods of shedding ice are limited. For example, some methods require manifolds and piping to reduce heat, which again add weight to the engine. Other methods of reducing ice formation or shedding such formation include mechanical means such as bladders or boots that expand and force to shedding of ice. These parts are generally of a relatively heavy nature, which is counter to efficiency desires.

As may be seen by the foregoing, there is a need to improve ice shedding capability or inhibit formation of such ice. Likewise, there is a continual need to improve engine efficiency, one method of doing so being reduction of engine weight.

### SUMMARY OF THE INVENTION

Some embodiments of the present disclosure involves an airfoil, such as a vane or blade, formed of a composite and having an embedded piezoelectric actuator which may be electrically excited and cause vibration at preselected locations to either inhibit formation or cause shedding of ice. The airfoil is formed of a composite material which is layered and includes at least one morphable area which may vibrate through the active actuation. Other embodiments include a metallic airfoil or other flowpath structures which include a surface mounted or near surface mounted piezoelectric actuator. Applications to static flowpath hardware, both composite and metallic are applicable.

According to various embodiments, a flow surface comprises a composite material formed of a plurality of layers of the composite, and a piezoelectric actuator located within the layers or on an outer surface of the composite material. The piezoelectric actuator is actuatable to vibrate the composite material and one of inhibit ice build-up or shed ice which has formed. The flow surface may be located on a guide vane. The guide vane may further comprise an outer platform and an inner platform at radial ends of the guide vane. The piezoelectric actuator may be located on the guide vane and cause vibration in a direction substantially perpendicular to a surface of the actuator. The piezoelectric actuator may be connected to a controller which signals the actuator to actuate. The flow surface may alternatively be a nose splitter. The flow surface may alternatively have an actuator disposed between a forward end and aft end of the nose splitter. The nose splitter may be connected to an inlet guide vane. The piezoelectric actuator is located on the nose splitter to vibrate the nose splitter and inhibit ice formation or break any formed ice. The flow surface may alternatively be an airfoil blade. All of the above outlined features are to be understood as exemplary only and many more features and objectives of the composite airfoil with piezoelectric actuator for ice shedding may be gleaned from the disclosure herein. Therefore, no limiting interpretation of this summary is to be understood without further reading of the entire specification, claims, and drawings included herewith.

### BRIEF DESCRIPTION OF THE DRAWINGS

The above-mentioned and other features and advantages of this disclosure, and the manner of attaining them, will become more apparent and the composite airfoil with piezoelectric actuator will be better understood by reference to the following description of embodiments taken in conjunction with the accompanying drawings, wherein:

FIG. 1 is a side section schematic view of an exemplary turbine engine;

FIG. 2 is an isometric view of an exemplary vane;

FIG. 3 is a partial side section of an exemplary guide vane assembly in a low pressure compressor;

FIG. 4 is an alternative embodiment having a blade type airfoil;

FIG. 5 is a top view of a portion of the blade of FIG. 4 including flexed positions shown from actuation in broken lines;

FIG. 6 is a section view of material layers defining the airfoil including the piezoelectric actuator; and,

FIG. 7 is a side view of an alternate flow surface having an actuator.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that embodiments of the present invention cover such modifications and variations as come within the scope of the appended claims and their equivalents.

Present embodiments provide an airfoil which may be formed of various layers of material which has one or more vibrating sections or portions. For example, one material may be a polymeric matrix composite (PMC). This allows for vibration of the airfoil at one or more locations. According to a second embodiment, the material may be a ceramic matrix composite (CMC). Other materials may be used, such as carbon based materials or metal-based materials for example, as well and therefore the description should not be considered limiting.

The terms fore and aft are used with respect to the engine axis and generally mean toward the front of the turbine engine or the rear of the turbine engine in the direction of the engine axis, respectively.

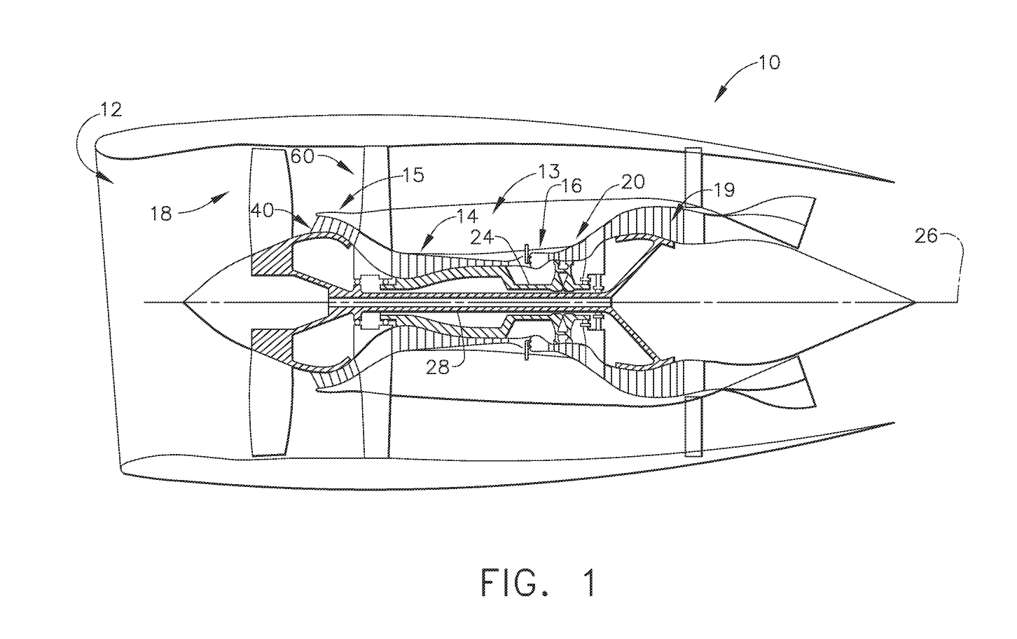

Referring now to FIGS. 1-7, various embodiments depict apparatuses and methods of utilizing an embedded piezoelectric actuator on a composite airfoil for shedding of ice. The airfoil may be used in a plurality of non-limiting areas of turbine engine including, but not limited to, a turbo fan, a compressor, and turbine. Alternatively, the shape changing airfoil design may include embodiments other than the turbine, such as in a wing, or other airfoil shapes or flowpath structures for example. The airfoil or flowpath structure may vibrate by way of actuated piezoelectric vibration. Typically vibration is achieved when the actuator is tuned to the natural frequency of the structure to maximize deflections and thus shed ice. Such ice shed may occur on a three dimensional structure by modulating the frequency to excite various circumferential regions.

Referring initially to FIG. 1, a schematic side section view of a gas turbine engine 10 is shown having an engine inlet end 12, a compressor 14, a combustor 16 and a multi-stage high pressure turbine 20. The gas turbine 10 may be used for aviation, power generation, industrial, marine or the like. The gas turbine 10 is axis-symmetrical about engine axis 26 or shaft 24 so that various engine components rotate thereabout. In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of the shaft 24.

The shaft 24 passes toward the front of the engine to continue rotation of the one or more compressor stages 14, a turbo fan 18 or inlet fan blades, depending on the turbine design. The axis-symmetrical shaft 24 extends through the turbine engine 10, from the forward end to an aft end. The shaft 24 is supported by bearings along its length. The shaft 24 may be hollow to allow rotation of a low pressure turbine shaft 28 therein. Both shafts 24, 28 may rotate about a centerline 26 of the engine. During operation the shafts 24, 28 rotate along with other structures connected to the shafts such as the rotor assemblies of the turbine 20, high and low pressure, and compressor 14, high and low pressure, in order to create power or thrust depending on the area of use, for example power, industrial or aviation.

Referring still to FIG. 1, the inlet 12 includes a turbo fan 18 having a plurality of blades. The turbofan 18 is connected by shaft 28 to the low pressure turbine 19 and creates thrust for the turbine engine 10. It should be understood that the instant embodiments may be utilized with various airfoils throughout different locations of the engine. For example, the actuators described may be with respect to the various blades of the turbofan 18, compressor 14 or turbine 20 as well as guide vanes in the compressor 14 or turbine 20 or the vibrating airfoil may be utilized with various airfoils within the turbine engine 10. Additionally, the vibrating airfoil may be utilized with various airfoils associated with structures other than the turbine engine as well.

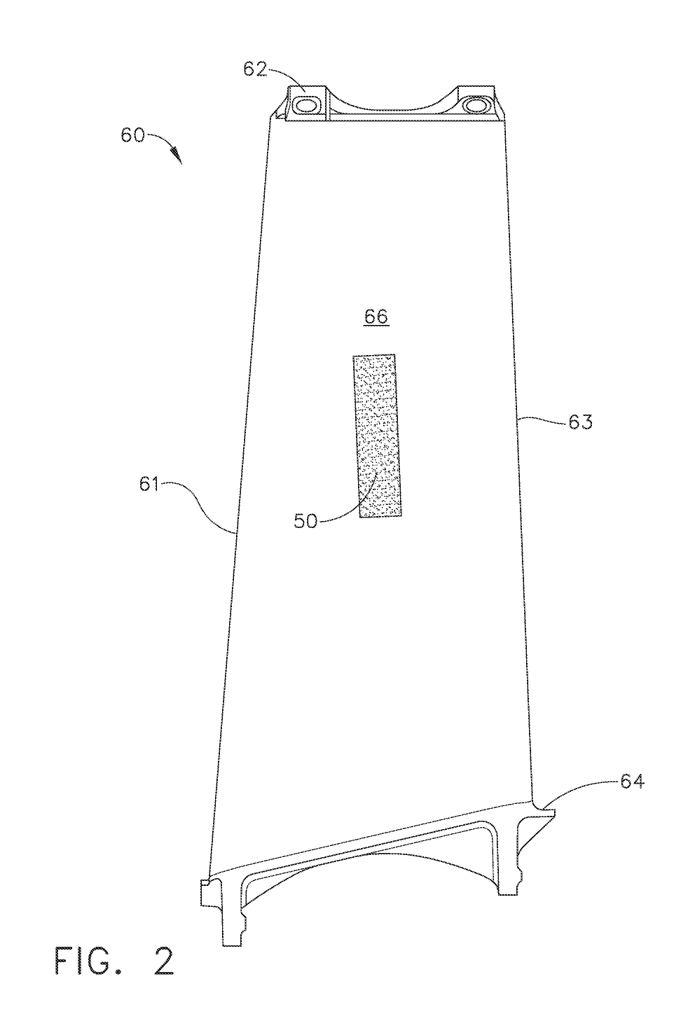

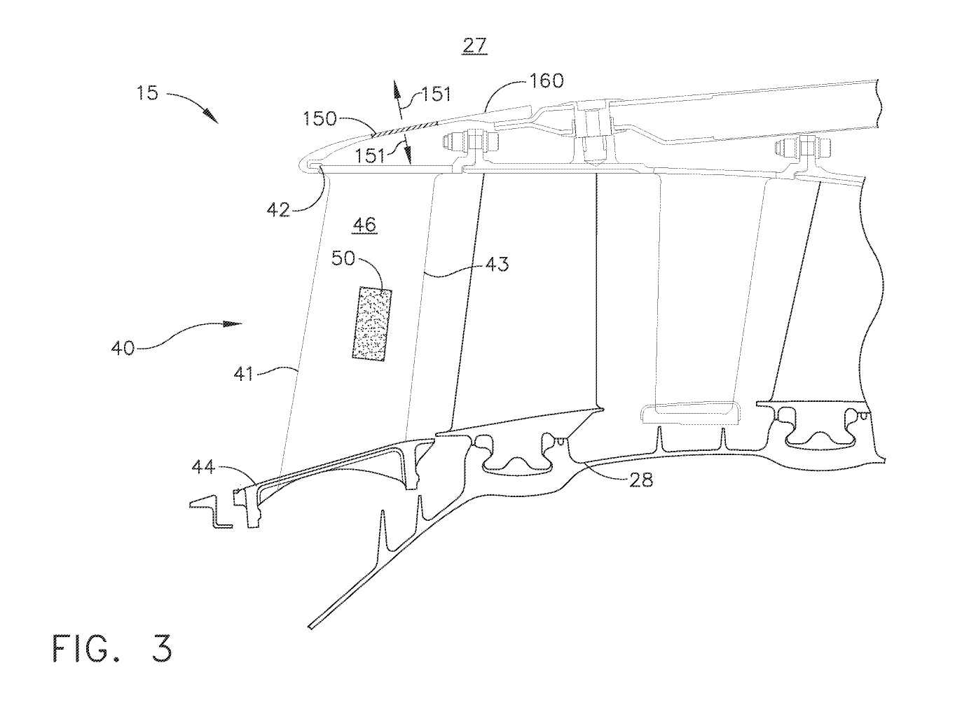

Referring now to FIG. 2, a side view of an exemplary outlet guide vane assembly 60. Air travels through the fan module 18 (FIG. 1) and is directed toward a leading edge of the guide vane assembly 60 (FIG. 2) or inlet guide vane 40 (FIG. 3). With regard to the assembly 60, the assembly comprises an outer band or connecter 62, an inner band or connecter 64, a leading edge 61 and a trailing edge 63. The outer and inner connectors 62, 64 may have various forms such as feet, platforms, bands or the like.

Referring now to FIG. 3, a partial side section view of the composite airfoil is depicted within a booster or low pressure compressor 15. The booster 15 comprises an inlet vane assembly 40 is formed of an upper (outer) band 42, a lower (inner) band 44 and a vane 46 extending therebetween. The vane 46 extends in an axial direction from the leading edge 41 to the trailing edge 43. Additionally, it should be understood that various guide vane structures may be utilized. For example, in the instant embodiment, the inlet guide vane may have one or more vane airfoils 46 extending between segments of the inner mount surface 44 and outer mount 42. Additionally, these structures may be formed to accommodate quick engine change structures for easy mounting or unmounting of vane assemblies.

Aft of the vane 40 is a rotating compressor blade which rotates with the low pressure turbine shaft 28. Each assembly 40 may include one or more vanes 46 within a segment that extends circumferentially. A plurality of segments extend circumferentially about the centerline 26 of the engine 10. The portion of the low pressure compressor 15 depicted is the inlet to this portion of the engine 10. The low pressure compressor or booster includes the vane airfoil 46 which is positioned between radially outer band 42 and a radially inner band 44. The airfoil vane 46 has a leading edge 41 and a trailing edge 43 which each extend between the outer and the inner mounts 42, 44. The airfoil 46 includes a suction side and a pressure side of the vane as will be understood by one skilled in the art.

With reference to FIGS. 2-3, located along the surfaces of the vanes 46, 66 is an exemplary piezoelectric actuator 50. The actuator 50 is shown on the surface but may be formed within the interior layers of the vane 46 as well. The actuator 50 may be formed of various shapes although the exemplary actuator 50 is shown as rectangular for simplicity.

The actuator 50 may be a piezoelectric actuator which causes vibration in a plane which is generally perpendicular to the surface of the actuator 50. Thus, in the depicted embodiment, the vibration displacement of the airfoil vane 46 may be into and out of the depicted figure. However, the vibration may be in various planes and is not limited. The actuator 50 is shown having a generally rectangular shape. The actuator shape may vary as the depicted embodiment is mainly representative. The actuator shape may be influenced by the location where the actuator is placed and/or the area where ice typically forms along the airfoil vane 46. In other words, various shapes may be utilized. The actuator 50 causes vibration in a direction generally perpendicular to the plane in which the actuator 50 is positioned.

Additionally, while a single actuator 50 is depicted, a plurality of actuators may be used along one or more surfaces either positioned together or spaced apart and connected electrically to include ice shedding capability. Additionally, the one or more actuators may be tuned to improve the vibratory displacement functionality of the vane 46 when the actuator 50 is operating. For example, if a plurality of actuators are used, the actuation may be such that all of the actuation occurs in phase or synchronized, or all of the actuation may occur in a manner which is out of phase from other actuators. Such tuning may occur in a design phase as the amount of ice shedding needed is determined.

Above the radially outer mount 42 is a flow surface 160, such as a splitter, defining a radially inner surface of a bypass duct 27. The flow surface 160 connects to the end flange of the mount 42 and extends diagonally and in an axial direction. According the instant embodiment, an actuator 150 is also embedded along this flow surface 160 to again inhibit ice formation or shed ice formation which may occur in this area. As previously described, the vibratory displacement of the surface 160 is in a direction which is generally perpendicular to the surface where the actuator 150 is located. This is generally depicted by vibratory arrows 151. The flow surface 160 connects to the forward end of the mount 42 and extends aft in a diagonal direction and depends downwardly in a radial direction for connection to case portions of the low pressure turbine 15.

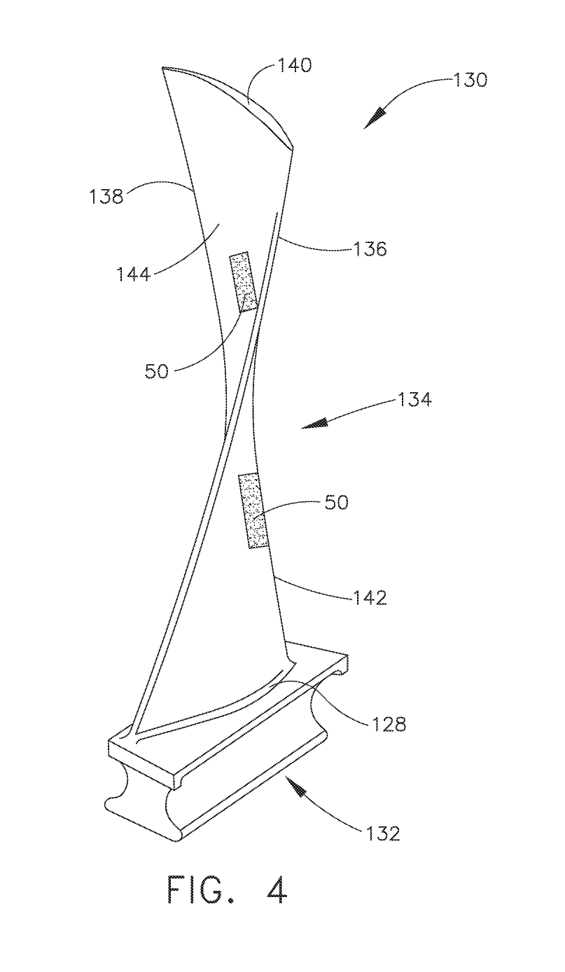

Referring now to FIG. 4, an isometric view of a compressor blade 130 is depicted. Such blade is utilized in a compressor but may alternatively be utilized in the turbine or other areas of the engine provided the composite material is suitable for use in the operating temperatures of the area of the engine at issue. Although a compressor blade 130 is shown and described, other components utilizing an airfoil shape may utilize the actuating ice shedding feature. The blade or airfoil 130 includes a root portion 132 which is connected to a, for example, rotor assembly within the compressor 14, the turbofan 18 or the turbine 20 of the turbine engine 10. For example, the root 132 may be received in the cavity of a rotor disk or may utilize other mechanical connection with the rotor. Extending from the root 132 is an airfoil portion 134 comprising a leading edge 136 and a trailing edge 138. The airfoil 134 includes a suction side 142 and a pressure side 144. The leading edge 136 and the trailing edge 138 are formed on the airfoil 134 portion of the blade 130. A radially outer end 140 extends between the leading and trailing edges 136, 138. Likewise, a radial inner end 128 extends between leading and trailing edges 136, 138 at the root 132. The blade 130 is formed of a composite material and may be solid, hollow, partially hollow or may be filled in whole or part with some low density material. The material of the airfoil 134 may be the same or different material from that of the root 132.

The blade 130 comprises at least one actuator 50 to aid with ice shedding which may occur on the blade, suction surface 142 or pressure surface 144. The actuator 50 again causes vibration of the surfaces to aid in shedding of existing ice or formation of ice which may occur on the surfaces.

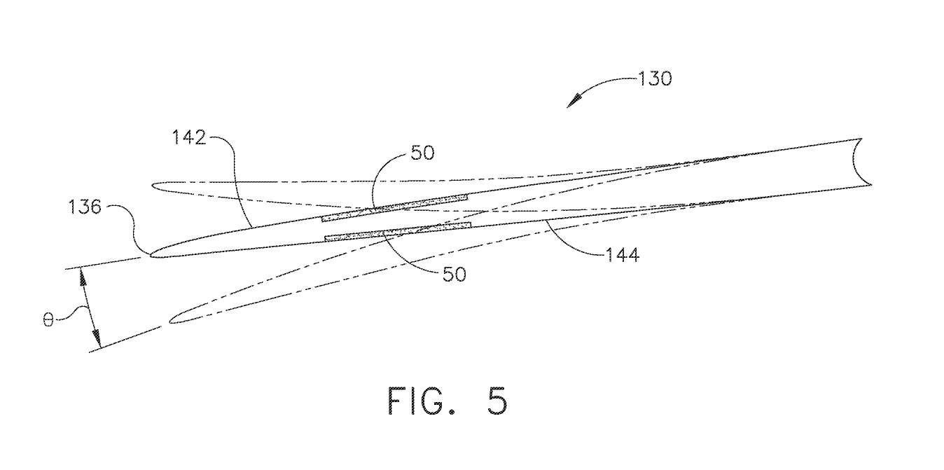

Referring now to FIG. 5, a detailed view of an exemplary blade is depicted having one or more actuators 50 located on at least one of the surfaces of the blade. The leading edge 136 is depicted and actuators 50 are positioned on the pressure and suction sides 144, 142. The actuators are shown positioned opposite one another. However, they may be offset in the axial direction as well as the radial direction. Alternatively stated, the actuators may be located at various positions of the airfoil 130 depending on the location where ice may have a tendency to form. As also shown in FIG. 5, the blade 130 is shown in two positions in broken line. These represent vibrational movements of the blade due to actuation of the at least one actuator 50. Such vibration inhibits the formation of ice or causes removal of the ice during operation. The angle of the movement is defined by angle theta (0) and such angle may be tuned by the size of actuator, the material thickness, the positioning of the actuators 50 or other characteristics.

Additionally, referring still to FIG. 5, the leading edge 136 may also have a vibrating portion 142. Thus, the blade 130 may include a single vibrating area or multiple vibrating areas, either of which may be at the leading edge, trailing edge or other portion of the blade 130.

The instant description applies to the exemplary blades as well as other blades which may be within the scope of the present disclosure. Referring again to FIGS. 3-5, the blade 130 including the actuators 50, may be located at the trailing edge 138 of the airfoil portion 134. The actuators 50 may alternatively be moved to various positions to provide desired vibration. Similarly, a vibrating area along the leading edge 136 may also be located at various positions of the airfoil 134.

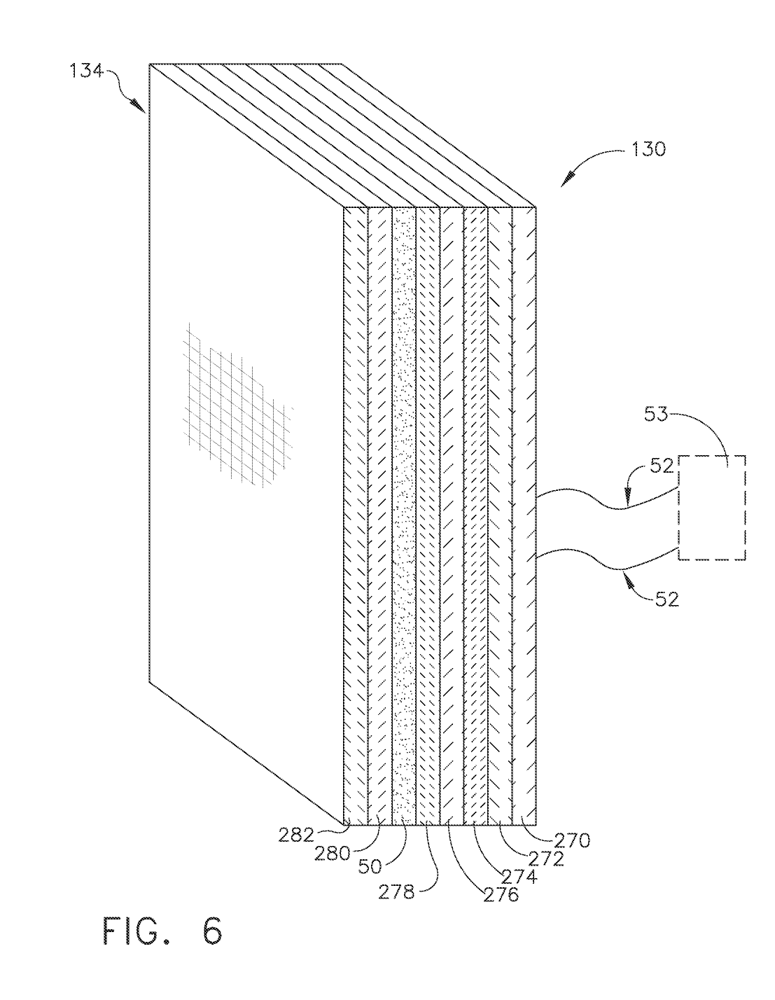

Referring to FIG. 6, the blade 130 is formed with multiple layers 270, 272, 274, 276, 278, 280 and 282 of composite material which build upon one another to form the desired shape of at least the airfoil portion 134. Although a number of layers are shown in the depicted embodiment, more layers or fewer layers may be utilized. According to one embodiment, the blade 130 may be formed of a polymeric matrix composite (PMC). According to other embodiments, carbon fibers, glass fibers, binders and combinations thereof may be utilized and may be laid in any of chordwise, sparwise, oblique directions or combinations thereof through the one or more layers. Within the airfoil portion 134, at a desired actuation location, the airfoil portion 134 may include one or more actuators 50, 150 which may shed ice or inhibit formation thereof. The active actuators 50 are embedded in a subsurface manner to cause one or more surface layers to vibrate actuated. In the depicted embodiment, the layer 282 represents an outer layer or protective coating. The at least one actuator 50, 150 may be located at various depths however it may be desirable to place the actuator 50, 150 are placed closer to the external surface layer as shown. Additionally, due to the embedded construction of the actuator 50, the leads 52 may extend from various locations of the blade 130. The various layers are shown in cross section and depict the multiple layers may be laid in the chordwise, sparwise, oblique directions, or a combination thereof, dependent upon the shape change desired. One or more airfoil regions may be designed to achieve the desired shape change. Additionally, it should be understood by one skilled in the art that while the instant embodiment depicts a composite material formed of layers, other embodiments may utilize metallic materials to form the flow surfaces.

The active actuation may occur by way of a piezoelectric actuator which is embedded in the composite laminate material defining the blade 130. The piezoelectric actuator 50 is an active actuator which receives a voltage input and vibrates by application of voltage to the piezoelectric actuator 50. By repeatedly actuating, the one or more layers may be caused to vibrate. The actuator 50 is positioned closer to the outer surface of the actuation area to cause ice shedding or preclude formation of ice. With use of this active actuator 50, more compliant composite materials may be utilized which are more capable of handling strain and require less driving force to deflect. One exemplary material which may be utilized may be S-glass in the actuation region and carbon for the remaining region of the airfoil 134. Thus the actuation area may be formed of the same, different or at least partially different materials than the remainder of the airfoil portion 134.

Active actuator leads 52 may be embedded in the composite material and terminated outside the structure to provide electrical voltage to the piezoelectric actuator 50, for example. With the actuator 50 embedded the actuator is protected from erosion and other damaging effects which may limit operation of the actuator 50. The leads 52 may exit at any location which does not interfere with performance and which does not damage the lead. Coatings for example may be used to cover the leads and protect such from damage.

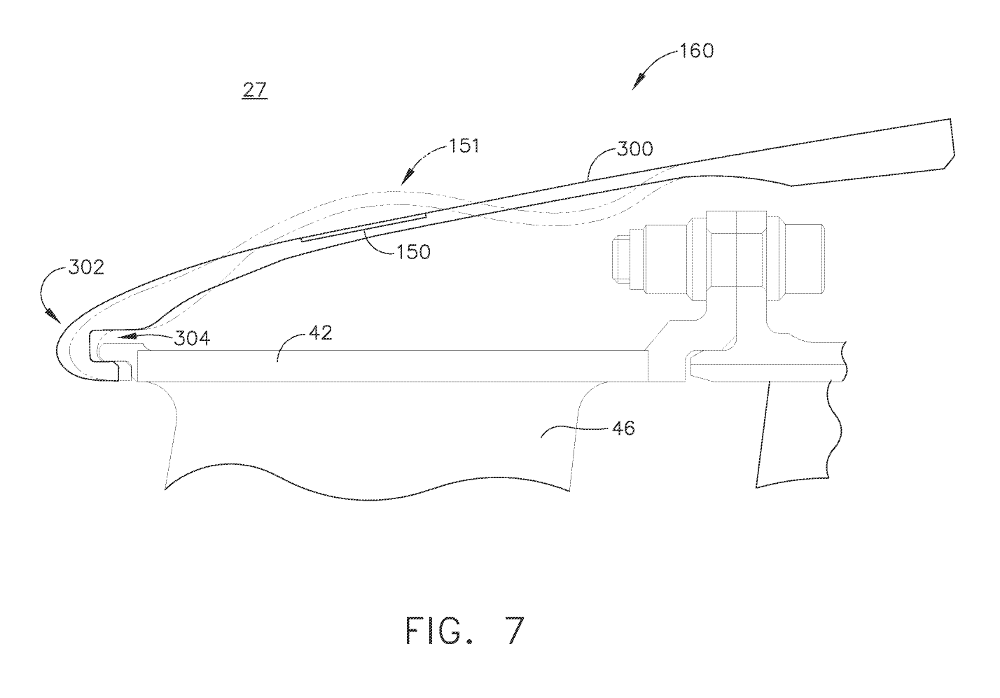

Referring now to FIG. 7, a detail side view of an additional type of flow surface 160 wherein ice accumulation is undesirable. Specifically, the flow surface 160 depicted in the instant embodiment is a nose splitter 300, depicted in a detail side view. The nose splitter 300 defines a structure which separates or splits air moving through the core 13 and air moving through a bypass duct 27. The nose splitter 300 includes a forward portion 302 which provides a recess 304. An outer end of the guide vane 46, a platform 42 is connected to the nose splitter 300 by a tab which engages recess 304. As shown previously, a piezoelectric actuator 150 is located on or within the nose splitter 300. The actuator 150 causes movement in the direction which is generally perpendicular to the surface where the actuator 150 is located. The actuator 150 may be located on or near the surface where the vibration for ice shedding is desirable.

As shown in the depicted embodiment, the upper surface of the nose splitter 300 is shown vibrating in broken line. The vibrating surface is moved from normal position shown in solid line. The movement of the surface 300 inhibits formation of ice and breaks up any ice that does begin to accumulate. The flexing or vibration of the nose splitter 300 may be controlled by varying the location of the actuator 150, the size of the actuator 150 and the thickness, modulation of the actuator forcing function, or other dimensions of the flow surface 60.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A flow surface, comprising:
a composite material formed of a plurality of layers of said composite;
a piezoelectric actuator located within said layers or on an outer surface of said composite material;
said piezoelectric actuator being actuatable to vibrate said composite material and one of inhibit ice build-up or shed ice. The flow surface of claim 1 wherein said flow surface is located on a guide vane.

2. The flow surface of claim 2, said guide vane including an outer platform and an inner platform at radial ends of said guide vane.

3. The flow surface of claim 3, said piezoelectric actuator located on said guide vane and causing vibration in a direction substantially perpendicular to a surface of said actuator.

4. The flow surface of claim 1 wherein said piezoelectric actuator is connected to a controller which signals said actuator to actuate.

5. The flow surface of claim 1 wherein said flow surface is a nose splitter.

6. The flow surface of claim 6, said nose splitter having an actuator disposed between a forward end and aft end.

7. The flow surface of claim 6, said nose splitter connected to an inlet guide vane.

8. The flow surface of claim 6 wherein said piezoelectric actuator is located on said nose splitter to vibrate said nose splitter and inhibit ice formation or break any formed ice.

9. The flow surface of claim 1, said flow surface being an airfoil blade.
